(19) United States
(12) Patent Application Publication
(10) Pub. No.: US 2021/0376789 A1
(43) Pub. Date: Dec. 2, 2021

(54) SOLAR CELL OR SOLAR PANEL ENERGY EXTRACTION SYSTEM

(71) Applicant: DIGILOG TECHNOLOGIES PTY LTD, Happy Valley (AU)

(72) Inventors: Keith John JURY, Coconut Grove (AU); Graham Charles WILKINS, Happy Valley (AU)

(73) Assignee: DIGILOG TECHNOLOGIES PTY LTD, Happy Valley (AU)

(21) Appl. No.: 17/288,323

(22) PCT Filed: Nov. 22, 2019
(86) PCT No.: PCT/AU2019/051288

§ 371 Date: Apr. 23, 2021

(30) Foreign Application Priority Data
Nov. 22, 2018 (AU) 2018904462

(51) Int. Cl. H02S 50/10; H02J 3/38

(52) U.S. Cl. CPC H02S 50/10; H02J 2300/26; H02J 3/381

(57) ABSTRACT

A photovoltaic system having at least one solar cell and a secondary direct current power supply connected to the at least one solar cell. The secondary power supply is configured for constant voltage operation to input power to the photovoltaic cell to maintain operation of the solar cell at or near an optimum voltage working level for the solar cell.

### TECHNICAL FIELD

The technical field of the present invention is harvesting electrical energy from photovoltaic (PV) panels. An application of embodiments is for improving energy output from PV panels operating outside of optimum operating conditions, for example in cloudy or shaded conditions.

### BACKGROUND

Photovoltaic (PV) panels comprise an array of electrically coupled PV cells (also referred to as solar cells), to generate DC electric power from solar energy. The drawback of all photovoltaic solar panels is the operating conditions of a solar cell is such that results with a very sharp IV curve (relationship between voltage and current) that is constantly changing with available light and amount of load applied to the panel/solar cell. Hence whilst the current is somewhat stable, the voltage fluctuates with the available light on the cell. With increase in light and accordingly output voltage, the load supplied by the solar panel may be increased accordingly. However, if too much instantaneous load is applied, the voltage will collapse and so too will the IV curve which dramatically reduces the ability for the solar cell to convert light energy into electricity. Thus, there is a requirement to manage energy extraction from panels of solar cells aiming to minimise circumstances where the cells operate inefficiently.

The most common form of managing energy extraction from a PV Cell is called MPPT (maximum power point tracking). Maximum Power Point Tracking (MPPT), or sometimes known as power point tracking (PPT), is a technique used commonly with wind turbines and photovoltaic (PV) solar systems to maximize power extraction under all conditions. Although it primarily applies to solar power, the principle applies generally to sources with variable power: for example, optical power transmission and thermophotovoltaics. MPPT methodology relies on constantly adjusting the maximum load being drawn from the solar cell/panel before the maximum voltage/current point is caused to collapse.

PV solar systems exist in many different configurations with regard to their relationship to inverter systems, external grid, battery banks or other electrical loads regardless of the ultimate destination of the solar power through, the central problem addressed by MPPT is that the efficiency of the power transfer from the solar cell depends on both the amount of sunlight falling on the solar panels/cells and the electrical characteristics of the load. As the amount of sunlight varies, the load characteristic that gives the highest power transfer efficiency changes, so the efficiency of the system is optimized when the load characteristic changes to keep the power transfer at highest efficiency. This load characteristic is called the maximum power point (MPP) and MPPT is the process of finding this point and keeping the load characteristic there. Electrical circuits can be designed to present arbitrary loads to the photovoltaic cells aiming to maintain the MPP for the current conditions, and then convert the voltage, current, or frequency to suit other devices or systems. MPPT solves the problems of choosing the best load to be presented to the cells in order to get the usable power out.

MPPT devices are typically integrated into an electric power converter system that provides voltage or current conversion, filtering and regulation for driving or delivering power various external loads, examples include power grids, batteries or motors. Solar inverters convert the DC power to AC power and may incorporate MPPT: such inverters sample the output power (I-V curve) from the solar modules and apply the proper resistance (load) so as to obtain maximum power. The power at the MPP (Pmpp) is the product of the voltage (Vmpp) and MPP current (Impp)

Some companies are now placing a maximum power point tracker into individual modules, allowing to each to operate peak efficiency despite uneven shading, soiling or electrical mismatch by the use of optimisers. Optimisers have a limited range of boost/buck capabilities and assist with MPPT in a limited controlled operating window.

Whilst at present there are other variational algorithms to enhance MPPT methodology to locate the IV peak, the foundation of all current methods is primarily based on MPPT methodology which relies on constantly adjusting the maximum load being drawn from the solar cell/panel before the maximum voltage/current point is caused to collapse. Increased light will cause the operating voltage to rise up to a maximum level of Open Circuit Voltage, whilst decreased light will cause the operating voltage to drop. This drop could be caused by morning/afternoon/cloud/shading conditions or simply the angle of incidence is such that the panel is not perpendicular to the sun. The current MPPT method entails the load being reduced or increased as to ensure the optimum operating voltage versus current point is obtained.

This load point is constantly varying and does not necessarily match optimum cell performance load point and causes the cell to work outside of its designed Vmp (Voltage Maximum Power Rating).

With increasing desire for increased use of renewable sources of energy there is an ongoing desire for alternative systems.

### SUMMARY OF THE INVENTION

According to one aspect, the present invention there is provided a solar energy extraction system comprising a power source with an output voltage equal to the optimum panel/solar cell voltage, which can be a singular solar cell or a string of solar panels that supplies the solar array with the optimum constant minimum voltage.

According to an aspect there is provided a photovoltaic power system, including at least one solar cell configured to receive a primary energy input from solar irradiance and a secondary DC energy input connected in parallel to said at least one solar cell, wherein the secondary DC energy input is configured to output power at a constant voltage, the constant voltage chosen to match a a designated voltage maximum power (Vmp) rating of the at least one solar cell, whereby the at least one solar array can draw power from the secondary DC energy input to maintain operating voltage of the at least one solar cell at Vmp.

In some embodiments the secondary DC energy input voltage is fixed. IN an example of such an embodiment the secondary DC energy input voltage is chosen to match a designated Vmp of the at least one solar cell at a maximum operating temperature of the at least one solar cell.

In some alternative embodiments the secondary DC energy input voltage is variable and the designated voltage maximum value is controlled to match a designated Vmp of the at least one solar cell at a current operating temperature of the at least one solar cell. Such embodiments can at least one temperature sensor configured to sense the current operating temperature of at least one solar cell. Embodiments may further comprise a controller configured to receive the current operating temperature and automatically adjust the secondary DC energy input voltage based on the Vmp for the current temperature.

In some embodiments if a load is applied and the solar cell's optimum voltage is maintained by the secondary power input during reduced light conditions, the solar cell will have a higher level of light to electrical conversion compared to the solar cell not having the second power source to maintain the optimum voltage.

In some embodiments under full light conditions, power is not drawn from the secondary power input.

In some embodiments said solar cells are usually connected in a series configuration, such that a shaded solar cell will cause all other solar cells in full sunlight with-in the series configuration to reduce energy production to a similar output of the shaded cell, a solar panel will have bi-pass diodes as so when it is shaded and the voltage drops to a particular level, the energy by-passes the solar panel and minimises the loss on the series string, utilising this new method of maintaining the string voltage with a secondary power source, when a solar cell/panel is shaded the remaining solar cells/panels in light are not affected by the shaded solar cell and can maintain full operation due the Vmp being maintained by the secondary power source, the loss of the system is that only of the shaded cell/panel.

In some embodiments the secondary Power input can be that of mains AC power converted to DC power, a battery or other similar supply sources that can supply DC energy.

### BRIEF DESCRIPTION OF THE DRAWINGS

FIG. 1 is a simplified block diagram of an embodiment of the system.

FIG. 2 is a block diagram of another embodiment of the system.

FIG. 3 is a graph illustrating the variation of voltage set point (Vsp) with temperature for a solar cell or array.

FIGS. 4a and 4b illustrate the effect on power generation in a single cell in full sun (FIG. 4a) and partially shaded (FIG. 4b) conditions where a secondary DC power supply is provided in accordance with an embodiment of the system.

FIGS. 5a and 5b illustrate the effect on power generation in a single cell in full sun (FIG. 5a) and partial shade (FIG. 5b) where MPPT is used.

FIGS. 6a and 6b illustrate the effect on power generation in an array of solar cells connected in series in full sun (FIG. 6a) and partial shade (FIG. 6b) where MPPT is used.

FIGS. 7a and 7b illustrate the effect on power generation in an array of solar cells connected in series in full sun (FIG. 7a) and partially shaded (FIG. 7b) conditions where a secondary DC power supply is provided in accordance with an embodiment of the system.

FIG. 8 is an example of an alternative embodiment of the system.

FIGS. 9a and 9b illustrate an example of operation of a conventional PV generation system using MPPT in full sun (FIG. 9a) and shaded (FIG. 9b) conditions.

FIGS. 10a and 10b illustrate an example of operation of an embodiment of the system in full sun (FIG. 10a) and shaded (FIG. 10b) conditions.

### DETAILED DESCRIPTION

Disclosed herein are various embodiments of a photovoltaic system comprising at least one solar cell and a secondary direct current power supply connected to the at least one solar cell. The secondary power supply is configured to input power to the photovoltaic cell to maintain operation of the solar cell at or near an optimum voltage working level for the solar cell.

To gain optimum performance from a solar cell, embodiments of the disclosed system control the operating voltage of the solar cell (or array of solar cells) artificially using a second power source, aiming to achieve the solar cell's optimum voltage working level, rather than the solar cell dictating this voltage from the result of the rising and lowering from various light and load conditions.

Solar cells perform optimally when operating at the designed Vmp (Voltage Maximum Power Rating). When operating at the Vmp the cells convert photons of solar energy to electricity with maximum efficiency. Therefore, optimal performance, and maximum power output, for a solar cell will be achieved when operating at the Vmp. Similarly, an array of cells connected in series will also have a Vmp for the array, for example, a solar panel will have a Vmp. The array Vmp is based on the Vmp of individual cells within the array, and reflects the Vmp for the array at which all of the cells in the array operate at or near their individual Vmp. Optimal solar energy conversion performance and therefore maximum power output for an individual cell or array of cells is achieved when operating at the Vmp. Vmp is an inherent property of the solar cell, or array, based on the physical properties. Vmp for cells or arrays (panels) is typically communicated by the manufacturer of the solar cells or array. Vmp can be affected by operating temperature so thermal coefficients for the Vmp will typically also be provided by manufacturers. These inherent properties of the solar panels and arrays are characterised by manufacturers through testing.

As stated above the optimal efficiency of a solar cell or array is achieved when operating at Vmp. This may be achieved in practice when operating conditions are good, with strong sunlight and no shading, where individual solar cells are receiving sufficient solar energy to attain and maintain operation at Vmp. But often in practice conditions are not optimal, time of day, clouds, shade from trees reduce the sunlight incident on array panels thus meaning there is insufficient energy for at least some cells to achieve Vmp. In a PV array where cells are connected in series (also referred to as a sting) the overall operating voltage of the array will be limited to that of the lowest performing cell. Thus, in circumstances where an array is partially shaded, or dust or debris on the surfaces of the panel cause some cells to operate less efficiently, the overall operating voltage will drop, therefore even for unshaded cells their operating voltage and therefore conversion efficiency will be reduced.

To achieve optimum solar cell performance, the solar cell's optimum Vmp needs to be maintained regardless of the varying load and varying solar exposure through-out the day. Though light conditions may vary, if a solar cell's Vmp is maintained, it will operate at the optimum level designed by the solar cell's manufacturer.

Embodiments of the present system provide a platform that ensures a secondary input to a PV panel/array that ensures that the PV array operates within its optimum output conditions which is set by the PV panel/solar cell manufacturer.

Embodiments provide a secondary DC power supply connected to the PV array to enable power to be injected into the into the PV array (or cell) to supplement the power generated by the cells of the array to enable Vmp, or close to Vmp, to be maintained and therefore solar cells operate at or near their maximum conversion efficiency.

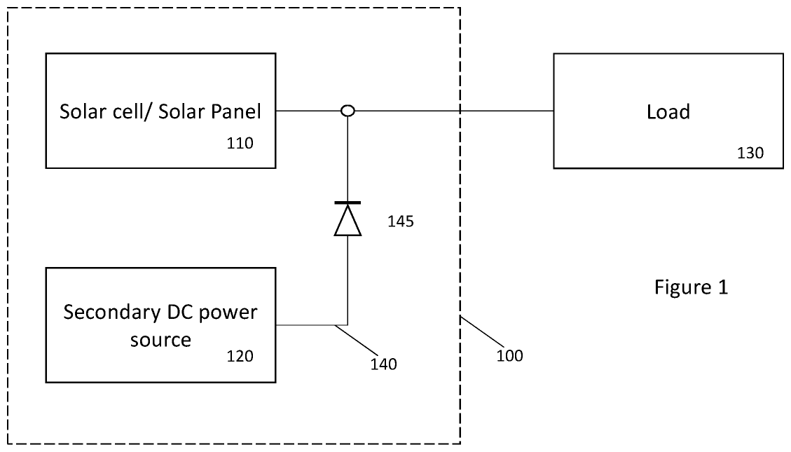

FIG. 1 shows a high level block diagram of an embodiment of the system 100. The first input is the energy from the solar cells 110 caused by light, whilst the second input is a DC power source 120 with a voltage that produces the optimum voltage of the combined solar cells. The generated power from the system 100 is consumed by load 130, for example this may be an inverter for conversion of the DC output power from the solar power generation system 100 to AC power supply for local use or supply to a power grid. Alternatively, the load 130 may be a direct consumer of the generated DC power, for example a DC motor.

The solar cell or array 110 may be any conventional solar cell or solar PV panel. The secondary DC power supply 120 is connected 140 in parallel with the solar cell or array at the output to the load. The DC power supply voltage is Vmp matched to the solar cell or array. A diode 145 ensures one wat power supply from the secondary DC power supply to the solar cell or array 110. The connection 140 however allows current to be drawn from the secondary DC power supply into the solar cell or array. Or in other words there is no blocking diode at the solar cell or array output, allowing electrons to flow freely in both directions at the output of the solar array. The effect of this configuration is that in circumstances where the solar cell (or cells of the array) is in low light or shaded, such that the cell is converting insufficient electrons to maintain Vmp, current is drawn from the DC power supply to supply electrons to the solar cell, or cells of the array, to maintain operation at Vmp. The impact of this is that the cells continue to convert what solar energy is available at maximum efficiency. Thus, even though there is some external power (from the secondary DC power supply) being consumed by the solar cell or array there is a net gain in output power, due to maintaining optimal conversion efficiency of the array.

Solar cells are designed to produce maximum power within a small voltage window. If the solar cell is caused to operate outside of this small window, the conversion from light to electron energy reduces dramatically.

The second power source 120 will ensure that the solar cell 110 is always operating within this window under all light/load conditions. The second power source 120 is a direct current power source, which may be mains powered, a battery, generator or any other DC power source. The second power source voltage is regulated to the solar cell/array correct Vmp operating window. Typically, the manufacturer specified Vmp for the typical operating temperature for the array installation.

It should be appreciated that operation of the system is essentially passive with the drawing of power from the secondary DC supply being inherent responsive to the cells. By connection of the solar cells or array in parallel with the secondary DC power supply, the circuit will maintain Vmp, and for the cells to maintain Vmp they will draw in electrons, from the DC power supply if the electrons being generated from soar energy are insufficient to maintain Vmp. Thus a PV array will essentially control the amount of power drawn from the secondary DC power supply to maintain operation at Vmp. For example, as a PV array is shaded by passing clouds, power begins to be drawn from the DC power supply to compensate for reduced electron generation and as the clouds pass and production of the cells again increases, less current is drawn from the secondary DC power supply.

In some embodiments the Secondary DC power supply may have a fixed voltage output, this being configured to Vmp, matched to the array, for the most common operating temperature conditions. Testing of prototypes by the inventors has demonstrated that efficiency gains can be achieved even if the Vmp of the array is not precisely matched by the secondary DC power supply under all operating temperatures. Operation near Vmp will also provide efficiency gains.

In some embodiments the system the secondary pawer supply may be an adjustable voltage power supply and the system may include temperature sensors and a controller configured to adjust the DC power supply output based on operating temperature of the PV array to maintain the output voltage of the secondary DC power supply at the Vmp for the array for the operating temperature.

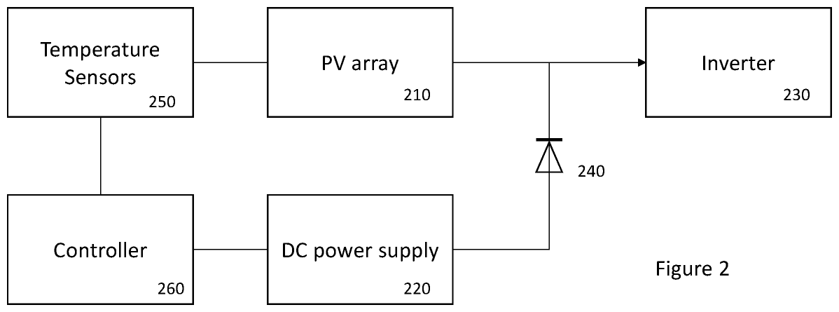

FIG. 2 shows a more detailed block diagram of an example of a system embodiment. In this example the solar array 210 is connected to the DC power supply 220 to enable injection of electrical power to the PV array 210. The DC power supply may be connected to or include a controller 260 which adjusts the variable DC voltage based on operating temperature of the PV array 210, detected by temperature sensors 250, connected to the PV array 210. The controller may include a microprocessor or programmable logic controller configured to calculate the Vmp for the sensed temperature based on manufacturer supplied Vmp and temperature coefficient data stored in device memory or coded into the program logic. It should be appreciated that the controller does not need to monitor the PV array output, and does not control the output power of the DC power supply 220, only sets the voltage. The power supplied by the DC power supply is organically controlled by the PV array. Organic electronic flow of electrons into the panel from the output this enables the whole panel to remain at the Vmp as set by the DC power supply.

As light on the solar cell reduces, so will the solar cell voltage. The second power source inhibits the solar cell voltage falling below the optimum voltage window. Preferably the second power source 120 is regulated to supply power which enables the solar cell (or array) to maintain Vmp. The secondary power supply supplies voltage to the solar cells, thus both the solar cells and the secondary power supply contribute to the supplied power to the load via the collar array output. Under this condition, voltage will be drawn from the secondary power source to the solar cell (for example, by the solar cell in accordance with the number of additional electrons the solar cell requires to supplement its own generation to maintain Vmp) and power supplied from both the solar cell and secondary power source to the load. It should be appreciated that the amount of power supplied by the DC power supply will increase with decreasing sunlight, to maintain Vmp in the array, and there will be a point where in power input to the system from the secondary DC power supply will exceed that produced by the solar cells. However, there can be practical benefits even in such circumstances, for example, where the darkened condition is transitory (for example passing dark clouds or temporary shadowing) the operation of the inverter will not be affected. In current systems drop in power output from the PV array can cause the inverter to shut down. Such systems are also typically configured to have a delay, a period in which sufficient output from the array must be achieved, before the inverter will be reset and brought back into operation. This is the protect the inverter and minimise inconsistency of input to the power supply grid from the PV system. Using the described secondary DC power supply to the array, substantially constant output to the inverter can be maintained even in greatly fluctuating solar energy conditions. The effect of fluctuating solar energy will be corresponding change in the power drawn from the DC power supply into the array, while the output to the inverter in maintained constant or substantially constant.

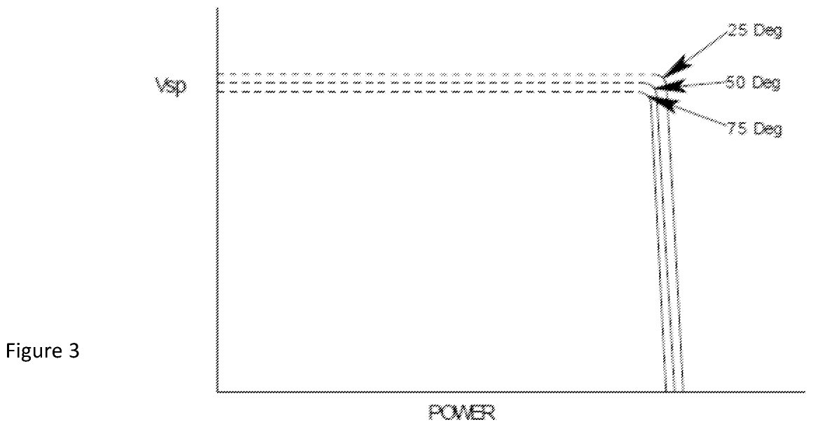

The relationship between solar cell and secondary power supply is linear. This relationship is determined by a known Vmp from the cell manufacturer and temperature of the panel. FIG. 3 illustrates the voltage set point (Vsp) and power relationship for a solar cell or array, and illustrates the difference of Vsp with temperature. The Vmp for different temperatures is typically supplied by cell or PV array manufacturers, and is based on inherent properties of the cell or array. As discussed above cells convert solar energy with greatest efficiency at Vmp. Vmp is temperature dependent and typically decreases with increase in temperature.

For an embodiment of the system as illustrated in FIG. 1, where there the secondary DC power supply operates at a fixed voltage (Vsp), then the Secondary DC power supply voltage (Vsp) can be fixed based on the manufactures Vmp at the highest cell operating temperature. As can be observed from FIG. 3, at lower temperatures a fixed Vsp may be marginally below the Vmp for the operating temperature. However, as this operation will be only marginally below the maximum efficiency, and maintained at that level even during fluctuating solar energy levels, the long term output form the PV array will be improved, compared with current MPPT based systems.

Considering the embodiment illustrated in FIG. 2, the overall output power gain can be slightly improved with input of cell temperature to the secondary DC power supply (or controller therefore) and adjustment of Vsp to Vmp for the current operating temperature. It should be appreciated that where Vsp is adjusted to the temperature variable Vmp some corresponding power output variation may also occur. However, such fluctuations will vary with array operating temperature which typically has a slow rate of change and thus minimal impact on inverter operation (or other loads).

In contrast as is commonly understood the V/I relationship (V/I curve) for a solar cell is non-linear. Solar Cells have a complex relationship between temperature and total resistance that produces non-linear output efficiency which can be analysed based on the I-V curve. It is the purpose of an MPPT system to sample the output of the PV cells and apply the proper resistance (load) to obtain maximum power for any given environmental conditions. Traditional solar inverters perform MPPT for entire PV array (module association) as a whole. In such systems the same current, dictated by the inverter, flows through all modules in the string (series). Because different modules have different I-V curves and different MPP's (due to manufacturing tolerance, partial shading etc) this architecture means some modules/cells will be performing below their MPP, resulting in lower efficiency conversion rates. As the incident solar energy changes the electricity generated by the cell also changes, with decreasing solar illumination the power generated by the cell, and thus the voltage and current that can be drawn drops. In systems using MPPT the apparent load applied is varied, aiming to manipulate the current and voltage to thereby maximum power able to be drawn from the solar cell (or array) during the low light conditions. But the overall power is limited by the solar illumination.

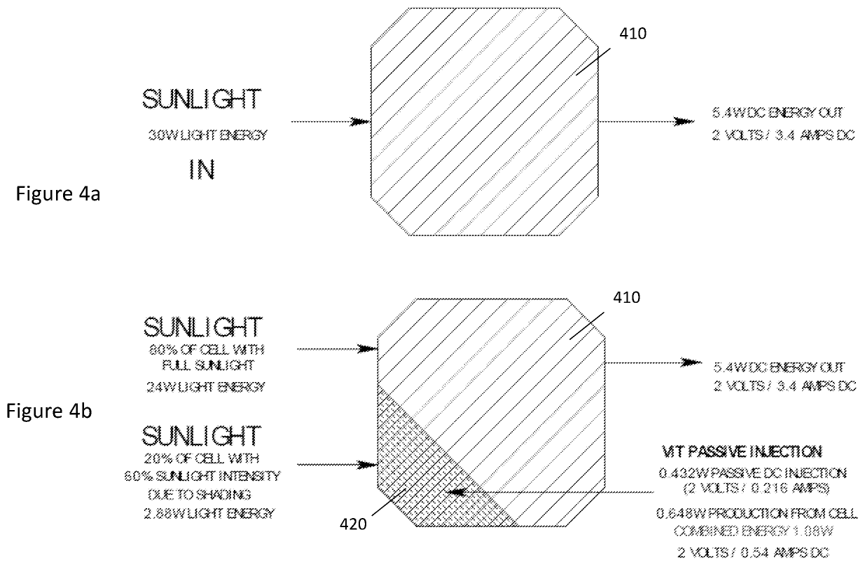

FIGS. 4a and 4b illustrate the effect on power generation in a single cell 410 in full sun (FIG. 4a) and partially shaded (FIG. 4b) conditions where a secondary DC power supply is provided to enable voltage injection. In this example, in FIG. 4a the cell 410 is fully illuminated and receives 30 W of energy from sunlight, to produce 5.4 WDC energy output, at 2 volts and 3.4 amps DC. FIG. 4b shows the cell 410 partially shaded 420. In this example, the cell is 80% illuminated by sunlight, receiving 24 W light energy, and 20% shaded to 60% sunlight light intensity, receiving 2.88 W of light energy. The Secondary DC power supply is connected in parallel to the cell and has a fixed voltage (Vdc) of 2 volts. In these shading conditions 0.432 W DC is passively drawn from the secondary DC power supply (2V at 0.216 AMPS DC). The shaded region of the cell produces 0.648 W of energy from the incident sunlight, this is supplemented by the 0.432 W drawn from the DC power supply to maintain the overall output from the solar cell at 5.4 W.

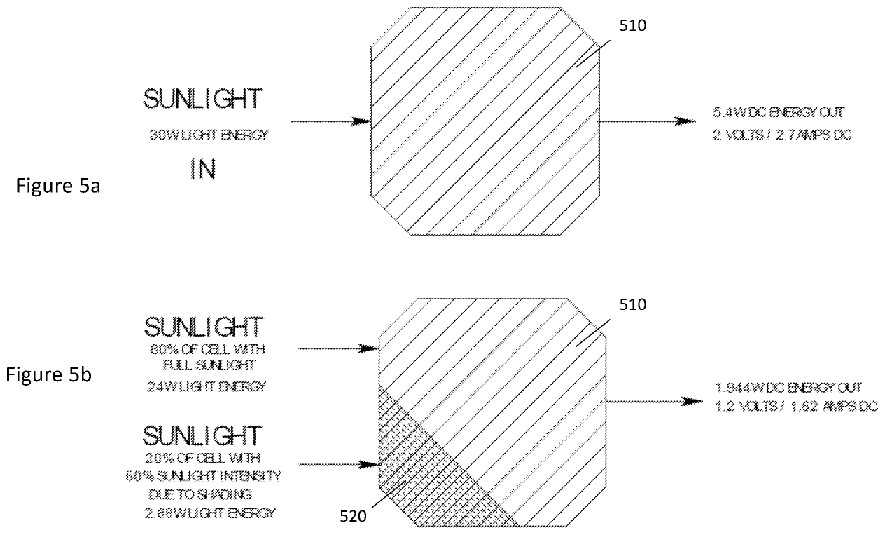

FIGS. 5a and 5b illustrate the effect on power generation in a single cell in full sun (FIG. 5a) and partial shade (FIG. 5b) where MPPT is used. Similar to the example of FIG. 4a, in full sunlight with 30 W sunlight energy incident on the cell 510, the cell 510 generates 5.4 WDC energy output, at 2 volts and 3.4 amps DC. FIG. 5b 4b shows the cell 510 partially shaded 520. In this example, the cell 510 is 80% illuminated by sunlight, receiving 24 W light energy, and 20% shaded 520 to 60% sunlight light intensity, receiving 2.88 W of light energy. Due to the shading the output power for the cell 510 drops, the MPPT may manipulate the apparent load on the cell, aiming to maximise power drawn. However, in this example this can only achieve 1.944 W DC, at 1.2 volts and 1.62 amps DC. The impact of shading part of the cell has also compromised the performance of the remaining part of the cell.

Solar cells are typically connected in series in an array. Reduced light resulting in reduced energy production from a single cell can affect the operation of a whole array of cells. Similarly, for panels of solar cells connected in an array (often referred to as a string), reduced performance of one panel can impact on energy production from the other panels in the array.

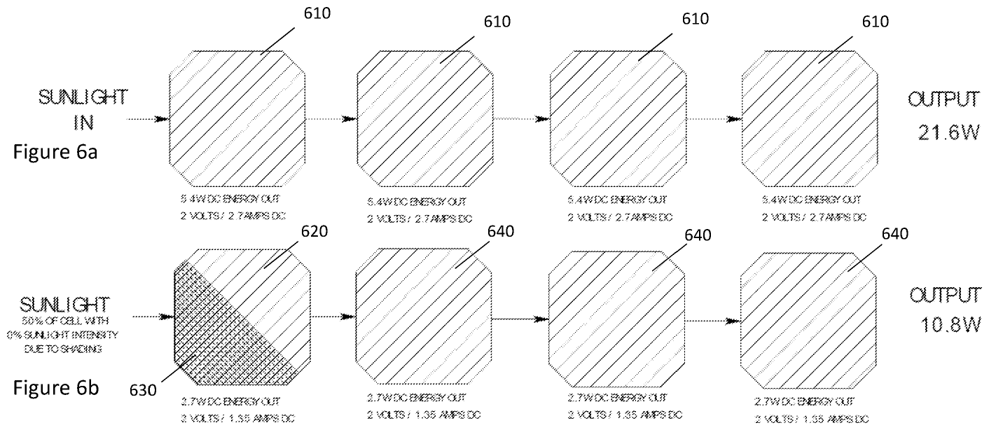

A normal panel produces energy with a sharp voltage versus current curve that requires the common MPPT method to find the constantly changing maximum power point to extract the maximum energy possible according to the available light on the panel. When a panel is outside of the MPP, the cells voltage will collapse causing the power to collapse and stop producing energy. One cell will affect every cell wired in series whether that be cells in one panel or a string of panels. An example of this is illustrated in FIGS. 6a and 6b which illustrate the effect on power generation in an array of solar cells connected in series in full sun (FIG. 6a) and partial shade (FIG. 6b) where MPPT is used. FIG. 6a illustrates the string of solar cells 610 in full sunlight. Each cell 610 generates 5.4 W CD energy (at 2 volts and 2.7 amps DC), for a total output from the string of 21.6 W. FIG. 6b illustrates the same string where one cell 620 is partially (50%) shaded 630 and the remaining cells 640 remaining full sunlight. In this example the power output from the shaded cell will drop, with a corresponding drop in operating voltage. The MPPT system will operate to reduce the apparent load on the array string aiming to bring the operating voltage back to or near the Vmp for the array, this control being based on maximising power that can be drawn from the array based on the V/I curve. Thus, with increase in voltage the current will drop (due to reduced load) so that the shaded cell 620 produces 2.7 W DC, at 2 volts and 1.35 amps DC. Due to the reduced load, operation of the entire string is limited by the operation of the shaded cell 620. The thus the power drawn from each cell of the string is limited to 2 volts at 1.35 by the shaded cell 620. Due to the V/I characteristics of the cells, the reminding unshaded cells 640 also produce only 2.7 W DC (2 volts, 1.35 amps) for a total output from the string of 10.8 W. Thus, shading of a single cell by dirt or debris (for example a leaf, bird droppings, rubbish or dust) or even slight shadowing (for example, from an antenna) can compromise the output for the entire string.

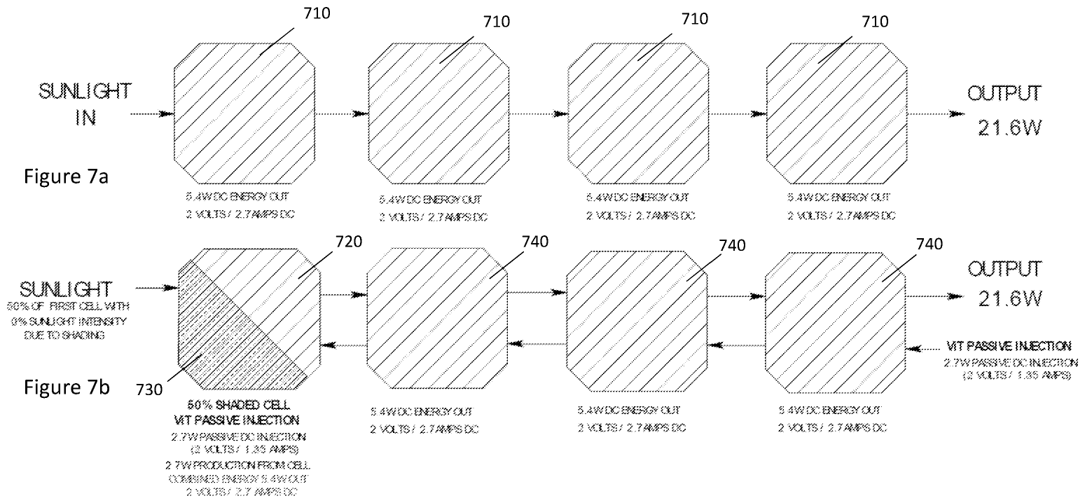

Embodiments of the present system prevent voltage collapse by injecting power close to the equivalent power that has been lost from shade, for example, solar cell has shade over cell causing 20w of shade, by injecting a similar amount of power that was lost, the rest of the cell will operate un-affected, which then allows the unshaded cells in series to continue to produce power unaffected. An example is shown in FIG. 7a, using the same string and shading example as for FIGS. 6a and 6b. Similarly, in this example, during full sunlight all of the cells 710 of the array generates 5.4 W CD energy (at 2 volts and 2.7 amps DC), for a total output from the string of 21.6 W. FIG. 7b illustrates the same string where one cell 720 is partially (50%) shaded 730 and the remaining cells 740 remaining full sunlight. In this example, the 2.7 W (2 volts, 1.35 amps) of power is injected by the secondary DC power supply, to maintain Vmp in the shaded cell (without reducing the load on the array as is done in MPPT), and the shaded cell produces 2.7 W (2 volts, 1.35 amps) to provide a combined output from the cell 720 of 5.4 W at 2 volts and 2.7 amps. In turn, this enables the remaining cell sin the string to maintain operation at 5.4 W (at 2 volts and 2.7 amps DC) for a total power output of 21.6 W to the inverter. It should be appreciated that the power output to the inverter is gross pawer output. As the system is consuming some energy from the secondary DC power supply to achieve this, the total net power generated is the gross power minus the power injected by the secondary power supply. However, due to the fact that the unshaded cells 740 continue to operate at maximum efficiency, the net power generated (21.6 W-2.7 W=18.9 W) still exceeds the output that could be achieved for the same scenario using MPPT.

A solar cell is able to convert more energy during low-medium level light when secondary power supply maintains correct Vmp. Due to Vmp being maintained, impact on the remaining panels in a string is minimised if a solar panel is shaded—the remaining panels on the string may continue to operate unaffected.

An added feature of injecting the voltage is that solar cells facing different orientations in a series string will operate at full capacity for its time of day/orientation as the voltage of the cell is managed by the second DC source. This allows for flexibility for solar design without the need for solar optimisers or one step further, allow solar cells/solar panels to have a curved surface as all the solar cells will work at its individual optimum potential.

The system describe herein can be referred to as Voltage injection Technology method (ViT), ViT is a different perspective of energy extraction from a solar cell. It comprises of the knowledge of the optimum voltage as specified from the manufacturer combined with temperature coefficient for optimum operating voltage (Vmp) for its given environment. A second DC source (ViT) is connected in parallel to the solar cell with the objective to inject a calculated voltage to ensure the solar cell operates at maximum performance for various given light conditions and maintain a consistent voltage where-as with the MPPT method, the voltage will rise and fall according to the intensity of light on the solar cell.

ViT ensures that the voltage in the solar cell remains constant which causes optimum operating conditions for the cell regardless of load or light conditions.

ViT will inject/replace lost power in a series string caused due to shade/non-optimal orientation and ensure that the unshaded/optimum solar cells work unaffected, whilst the shaded/non-optimum solar cells still operate to the best of their ability with the given light available.

In some PV panels blocking or bypass diodes are installed in every panel with attempt to assist the current flow through a solar panel that is in heavy shade. Where using ViT the blocking diodes may be removed. This may also result in improved performance.

The Secondary DC power supply may be a battery unity, DC generator or mains connected DC power supply. It may be feasible in some embodiments for the secondary DC power supply to be another PV power supply or other renewable energy power supply system.

Another advantage of embodiments of ViT systems is the benefit of energy being absorbed in low level light conditions, due to the second DC source managing the Voltage where-as in normal operating conditions, the voltage would collapse by having the second DC power source the solar cells Voltage does not collapse and cause the solar cell to continue to operate more efficiently than if the voltage dropped outside of the optimum window.

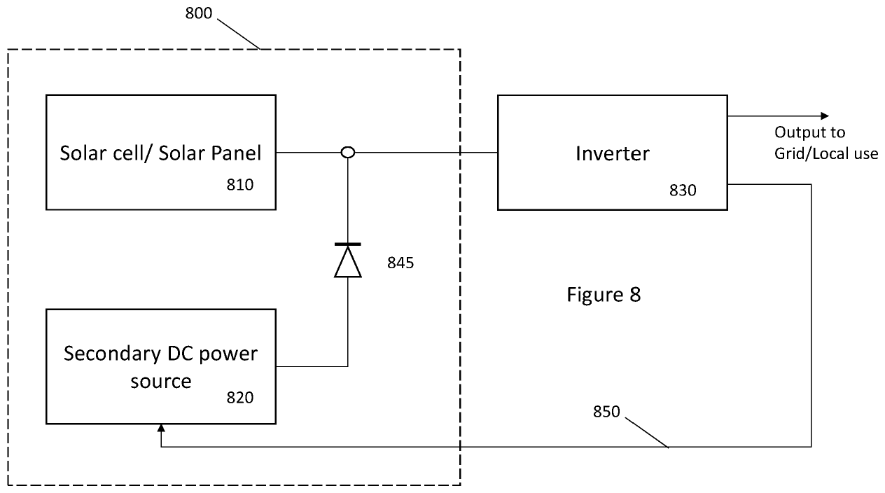

It was found that there is a point where the second DC input could succeed the primary solar input and hence would not be of benefit to the solar cell but could be of benefit to an inverter for continuous power production if the second source is from an energy storage source (battery) or generator. This can also have advantages for smooth transition to power supply from the DC power supply only—for example at night. An example of a system is shown in FIG. 8, in this embodiment the DC power supply 820 is battery storage bank, which stores power output form the inverter 830, which is excess to requirements of the local power use (for example a household or factory) or power grid input requirements, for example, during the day while the solar array 810 is operating in full sunlight and no (or little) power is being drawn from the secondary DC power supply. As the incident solar energy drops, for example at dusk, the DC power supply 820 will provide energy into the array to maintain Vmp and consistent output to the inverter 830. Thus, the natural transition to night will result in a natural transition to the power to the inverter being supplied from the battery storage 820. An advantage of this arrangement is that DC switching is avoided. Further, at dawn as sunlight becomes incident on the solar array 810 a reverse transition will occur with increasing power generation from the solar array 810 and reduction in power drawn from the battery storage. This allows a smooth seamless transition between predominantly or exclusively solar supply and battery power supply.

### COMPARATIVE EXAMPLES

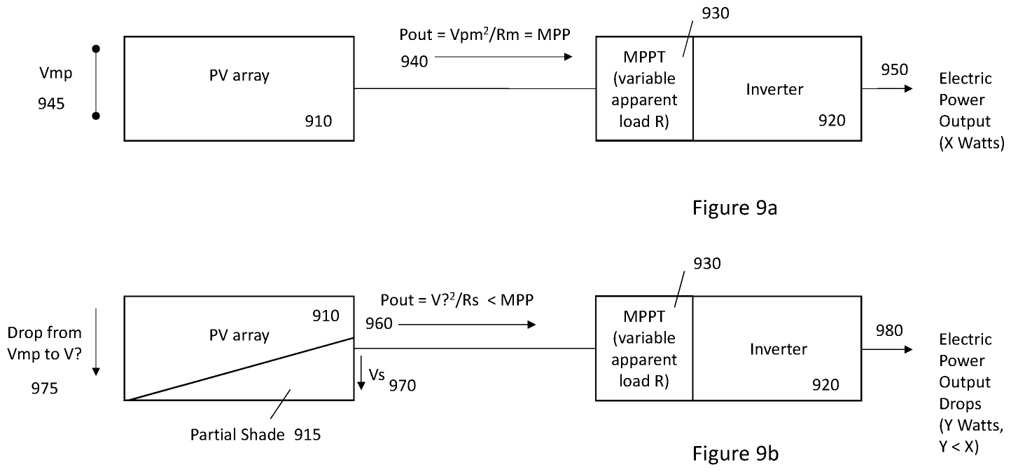

FIGS. 9a and 9b illustrate an example of operation of a conventional PV generation system using MPPT in full sun (FIG. 9a) and shaded (FIG. 9b) conditions.

As shown in FIG. 9a, where the array 910 is operating at Vmp in full sun, he MPPT 930 will adjust the variable apparent load (R=Rm) to draw maximum power from the array and the power output (Pout) 940 will be at MPP, resulting in XW power output 950 from the inverter 920.

As shown in FIG. 9b, if the PV array 910 is partially shaded 915, then the voltage in the shaded region Vs 970 will initially drop, and the MPPT 930 adjust the apparent load R, reducing this to Rs, aiming to bring the voltage of the array back up to or close to Vmp (V?). Resulting in a reduction on power 960 from the whole array and reduced output from the inverter 980 YW where Y<X.

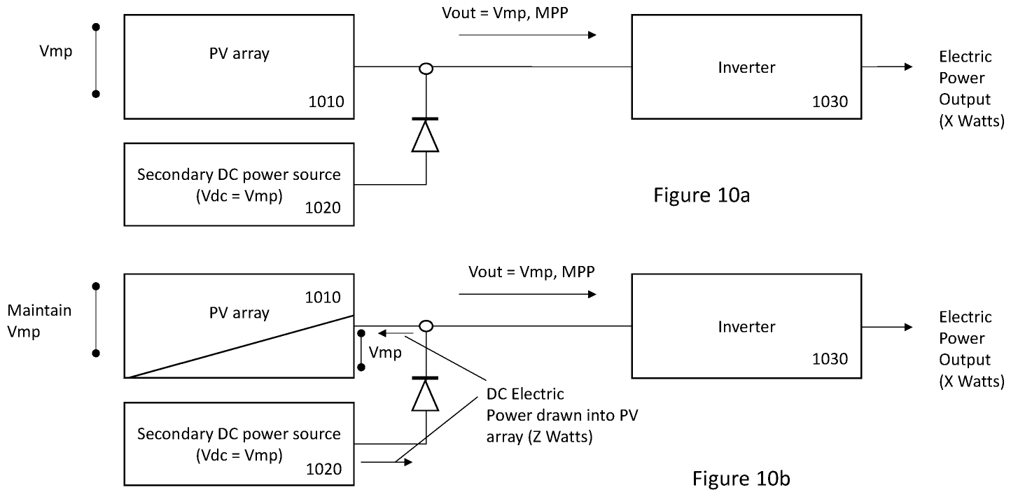

FIGS. 10a and 10b illustrate an example of operation of an embodiment of the system in full sun (FIG. 10a) and shaded (FIG. 10b) conditions. In full sun (FIG. 10) the PV array 1010 operates at Vmp producing maximum power. The secondary DC power supply 1020 voltage output is set to Vmp for the array at the current operating temperature. The output form the array is at the maximum power point MPP, generating XW output from the inverter 1030. FIG. 10b illustrates shaded conditions, where power at Z wats is drawn into the solar array from the DC power supply 1020 to maintain Vmp in the PV array 1010 and thus maintain maximum power input to the inverter 1030 which continues to output X watts of power. The net power generated is X-Z watts.

For example, an Mppt system comprising 5×300 W solar modules producing 1000 w. If an object shades 30% of one panel, causing panel I-V curve to collapse, this in-turn causes the panel performance to drop down by approximately 70% as the voltage significantly drops due to the shade, this then restricts all other panels in the string down to the same performance as the shaded panel causing a total array output of 300 W.

For a ViT system comprising 5×300 W solar modules producing 1000 W. An object shades 30% of one panel. ViT maintains the correct working voltage and injects 75 W which directly replaces the energy directly lost by the 30% of shade. The solar array delivers 1000 W to the appliance, whilst 75 W is being injected by ViT causing a Net wattage of 925 W

It was found that benefits of ViT would provide benefits down to a cellular level and would cause an overall net gain in energy production until the energy injected equalled the net energy gain. After the energy neutral point has been achieved, the solar cells continued to operate though the net gain had diminished. At this point the ViT energy was more than the solar energy and hence not providing much benefit unless the ViT energy is that from an energy storage source such as a battery.

Examples of Prototype test results comparing Mppt Versus ViT in different test situations.

### Test 1.

Mppt Inverter with 6×300 W modules connected in series to one Mppt. (total 1800 W) All panels, north facing towards sun, total wattage is 1500 W
One solar panel in the string is completely shaded, total power of inverter drops to 80 W
One solar panel in the string is partially shaded, total power from of the inverter drops to 150 W
One panel is turned around to east. All panels drop down to power level of east facing power with total power of inverter to 420 W
One panel is turned around to face west. All panels drop down to power level of west facing panel with total power at inverter of 560 W

### Test 2.

ViT Inverter with 6×300 W modules connected in series to on Mppt, with ViT connected at inverter. All panels, north facing towards sun, total wattage is 1500 W
One solar panel in the string is completely shaded, total power of inverter stays at 1500 W, ViT injects 250 W causing a net power production of 1250 W
One solar panel is partially shaded, total power at the inverter stays 1500 W, ViT injects 75 W causing a net power production of 1425 W
One solar panel is turned around to face east. Inverter total power is at 1500 W, ViT injects 125 W causing a net power production of 1375 W
One solar panel is turned around to face west, Inverter total power is at 1500 W, ViT injects 100 W causing a net power production of 1400 W

Although in embodiments and examples discussed above power form the PV array is output to an inverter this is merely an example of an application for the system. Output may be to any load configured to receive DC power. For example, the load may be an electric motor, battery storage, DC to AC power conversion system etc. The system is applicable to any DC power supply application.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A photovoltaic power system, including:
at least one solar cell configured to receive a primary energy input from solar irradiance;
and a secondary DC energy input connected in parallel to said at least one solar cell, wherein the secondary DC energy input is configured to output power at a constant voltage, the constant voltage chosen to match a a designated voltage maximum power (Vmp) rating of the at least one solar cell, whereby the at least one solar array can draw power from the secondary DC energy input to maintain operating voltage of the at least one solar cell at Vmp.

2. The photovoltaic power system in accordance with claim 1 wherein the secondary DC energy input voltage is fixed.

3. The photovoltaic power system in accordance with claim 2 wherein the secondary DC energy input voltage is chosen to match a designated Vmp of the at least one solar cell at a maximum operating temperature of the at least one solar cell.

4. The photovoltaic power system in accordance with claim 1 wherein the secondary DC energy input voltage is variable and the designated voltage maximum value is controlled to match a designated Vmp of the at least one solar cell at a current operating temperature of the at least one solar cell.

5. The photovoltaic power system in accordance with claim 4 further comprising at least one temperature sensor configured to sense the current operating temperature of at least one solar cell.

6. The photovoltaic power system in accordance with claim 5 further comprising a controller configured to receive the current operating temperature and automatically adjust the secondary DC energy input voltage based on the Vmp for the current temperature.

7. The photovoltaic power system in accordance with claim 1, wherein if a load is applied and the solar cell's optimum voltage is maintained by the secondary power input during reduced light conditions, the solar cell will have a higher level of light to electrical conversion compared to the solar cell not having the second power source to maintain the optimum voltage.

8. The photovoltaic power system in accordance with claim 1, wherein under full light conditions, power is not drawn from the secondary power input.

9. The photovoltaic power system in accordance with claim 1, wherein said solar cells are usually connected in a series configuration, such that a shaded solar cell will cause all other solar cells in full sunlight with-in the series configuration to reduce energy production to a similar output of the shaded cell, a solar panel will have bi-pass diodes as so when it is shaded and the voltage drops to a particular level, the energy by-passes the solar panel and minimises the loss on the series string, utilising this new method of maintaining the string voltage with a secondary power source, when a solar cell/panel is shaded the remaining solar cells/panels in light are not affected by the shaded solar cell and can maintain full operation due the Vmp being maintained by the secondary power source, the loss of the system is that only of the shaded cell/panel.

10. The photovoltaic power system in accordance with claim 1, wherein the secondary Power input can be that of mains AC power converted to DC power, a battery or other similar supply sources that can supply DC energy.
